(19) United States
(12) Patent Application Publication
(10) Pub. No.: US 2009/0187449 A1
(43) Pub. Date: Jul. 23, 2009

(54) System and method for managing unscheduled maintenance and repair decisions

(76) Inventors: Paul A. van Tulder, Burien, WA (US); Dian Gail Alyea, Algona, WA (US); William D. Kelsey, Issaquah, WA (US); Alan E. Bruce, Kent, WA (US); Robert L. Berg, Orting, WA (US)

Correspondence Address: MOORE AND VAN ALLEN PLLC FOR BOEING, 430 DAVIS DRIVE, SUITE 500, MORRISVILLE, NC, 27560, US

(21) Appl. No.: 12/017,533

(22) Filed: Jan. 22, 2008

(51) Int. Cl. G06F 17/00

(52) U.S. Cl. 705/8; 705/7

(57) ABSTRACT

A system for managing unscheduled maintenance and repair decisions may include a maintenance swap options prioritizer. The maintenance swap options prioritizer may include a data access and transformation module to find and assemble information from different sources for computing performance data and generating a list of prioritized swap options. The maintenance swap options prioritizer may also include an options selection module to generate the list of prioritized swap options based on the information found and assembled by the data access and transformation module and based on any user preferences. The maintenance swap options prioritizer may also include means to present the performance data and list of prioritized swap options to at least one user. The maintenance swap options prioritizer may further include means to permit collaborative decision making and planning by multiple users to manage shared maintenance and repair resources.

### COPYRIGHT NOTICE

A portion of the disclosure of this patent document contains material that is subject to copyright protection. The copyright owner has no objection to the facsimile reproduction by anyone of the patent document, or the patent disclosure, as it appears in the Patent and Trademark Office patent files or records, but otherwise reserves all copyright rights whatsoever.

### BACKGROUND OF THE INVENTION

The present invention relates to maintenance and repair of equipment, such as aircraft or other vehicles, and more particularly to a system and method for managing unscheduled maintenance and repairs of aircraft or other equipment or vehicles.

An unscheduled or unexpected maintenance task or repair that causes an aircraft to be taken out of service can significantly disrupt flight operations of an airline. The results can also have down stream disruption or delay ripple effects that can last for several days. Decisions with respect to different options, such as swap options, swapping different aircraft or equipment, or aircraft tail swap options or decisions (as such options may be referred to in the industry), or other courses of action to deal with the unexpected maintenance task or repair can also have different impacts or consequences with different levels of severity. The impacts or consequences may also be different or have different levels of impact or severity on different entities or organizations whose operations may be coupled to that of maintenance operations.

### BRIEF SUMMARY OF THE INVENTION

In accordance with another embodiment of the present invention, a system for managing unscheduled maintenance and repair decisions may include a maintenance swap options prioritizer. The maintenance swap options prioritizer may include a data access and transformation module to find and assemble information from different sources for computing performance data and generating a list of prioritized swap options. The maintenance swap options prioritizer may also include an options selection module to generate the list of prioritized swap options based on the information found and assembled by the data access and transformation module and based on any user preferences. The maintenance swap options prioritizer may also include means to present the performance data and list of prioritized swap options to at least one user. The maintenance swap options prioritizer may further include means to permit collaborative decision making and planning by multiple users to manage shared maintenance and repair resources.

In accordance with another embodiment of the present invention, a method for managing unscheduled maintenance and repair decisions may include finding and assembling information from different sources for computing performance data and generating a list of prioritized swap options. The method may also include generating the list of prioritized swap options based on the information found and assembled from the different sources and based on any user preferences and presenting the performance data and the list of prioritized swap options to at least one user. The method may further include permitting collaborative decision making and planning by multiple users to manage maintenance and repair decisions.

In accordance with another embodiment of the present invention, a method for managing unscheduled maintenance and repair decisions may include permitting assessment of an unscheduled maintenance task associated with an airplane. The method may also include generating a list of potential prioritized airplane tail swap options and presenting the list of potential prioritized airplane tail swap options to at least one user. The method may further include evaluating various flight operation constraints and user preferences in selecting one of the prioritized airplane tail swap options.

In accordance with another embodiment of the present invention, a computer program product for managing unscheduled maintenance and repair decisions may include a computer usable medium having computer usable program code embodied therewith. The computer usable medium may include computer usable program code configured to find and assemble information from different sources for computing performance data and generating a list of prioritized swap options. The computer usable medium may also include computer usable program code configured to generate the list of prioritized swap options based on the information found and assembled from the different sources and based on any user preferences. The computer usable medium may also include computer usable program code configured to present the performance data and the list of prioritized swap options to at least one user. The computer usable medium may further include computer usable program code configured to permit collaborative decision making and planning by multiple users to manage maintenance and repair decisions.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a block schematic diagram of an example of a system for managing unscheduled maintenance and repair decisions in accordance with an embodiment of the present invention.

FIG. 2 is a flow chart of an example of a method for managing unscheduled maintenance and repair decisions in accordance with another embodiment of the present invention.

FIG. 3 is an illustration of an example of timelines of integrated-schedule events to facilitate maintenance and repair decisions and situational awareness in accordance with an embodiment of the present invention.

FIG. 4 is an illustration of an example of timelines of integrated-schedule events depicting different possible solutions or swap options to facilitate maintenance and repair decisions and situational awareness in accordance with an embodiment of the present invention.

FIG. 5 is an illustration of an example of timelines of integrated-schedule events depicting different possible solutions or swap options with an inbound flight delay to facilitate maintenance and repair decisions and situational awareness in accordance with an embodiment of the present invention.

FIG. 6 is an illustration of an example of a graphical user interface for selecting or entering an inbound flight on which a need for an unscheduled maintenance task has arisen into a system for managing maintenance and repair decisions in accordance with an embodiment of the present invention.

FIG. 7 is an illustration of an example of a graphical user interface for presenting the inbound flight information selected or entered in FIG. 6 and for entering an outbound flight ready time in accordance with an embodiment of the present invention.

FIG. 8 is an illustration of an example of a graphical user interface for displaying options to resolve unscheduled maintenance and repairs and to make decisions in accordance with an embodiment of the present invention.

FIG. 9 is an illustration of an example of a graphical user interface illustrating promotion or changing the ranking of a maintenance swap option or candidate in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, portions of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “unit,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a tangible medium such as a portable computer diskette, a hard disk, a random access memory (RAM), a read-only memory (ROM), an erasable programmable read-only memory (EPROM or Flash memory), an optical fiber, a portable compact disc read-only memory (CD-ROM), or other tangible optical or magnetic storage devices; or transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

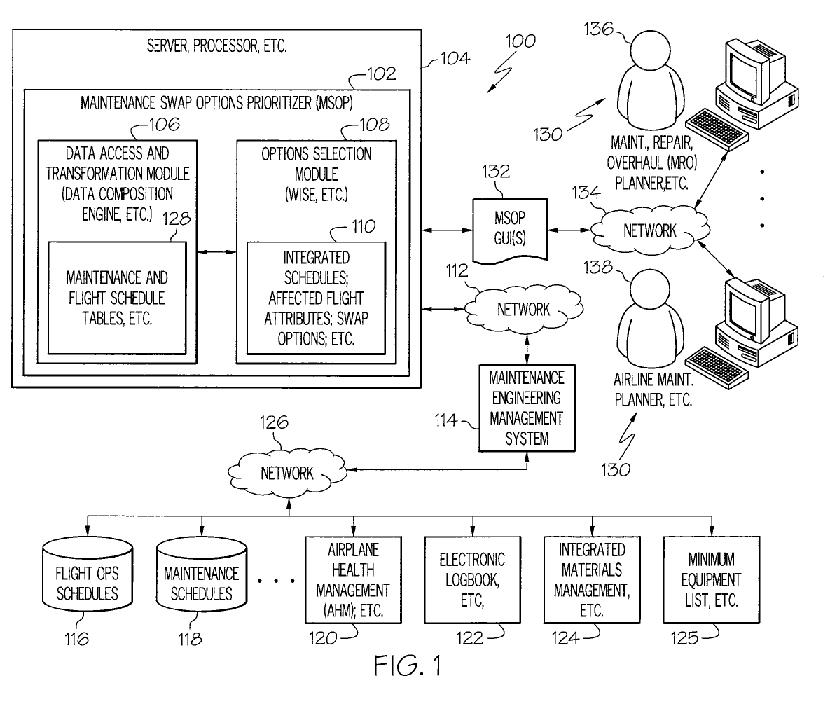

FIG. 1 is a block schematic diagram of an example of a system 100 for managing unscheduled maintenance and repair decisions in accordance with an embodiment of the present Boeing invention. As described in this application, the newly invented system 100 may provide an assortment of different prioritized options, such as swap options, that allow the user to swap different aircraft or any other transportation equipment, or aircraft tail swap options or decisions (as such options may be referred to in the industry), or choose other courses of action to deal with an unexpected maintenance task or repair.

Furthermore the newly invented system 100 could provide prioritized maintenance swap options or candidates and situational awareness, and could compute performance data or metrics for making unscheduled maintenance and repair decisions with minimal impact. In general, the performance data or metrics is intended but not restricted to include actual and planned times for airplane arrivals, departures, en route flight times, gate operations, such as refueling, baggage loading and unloading, passenger loading and unloading and other operations, which may impact dispatch availability of an operators vehicles. Such performance data or metrics may affect how impact delays or delay ripple effects, transportation legs remaining criteria and other criteria are determined. Such data or metrics may also affect when scheduled and/or unscheduled maintenance is executed or deferred.

Using the airline industry simply as an example, all civilian airplanes are identified by a registration number. The registration number is typically displayed on an aft portion of the aircraft's fuselage just forward of the tail. In earlier times, the registration number was more often displayed on the tail itself. Hence, an airplane's registration number is often referred to as the “tail number”. As used in this disclosure, airplane tail swap options, swap options, swap candidates, or similar terminology refer to an airplane's registration number or tail number. Accordingly, swap options, swap candidates or similar terminology used herein may identify different airplanes which may be swapped or replace another airplane that has experienced an unscheduled maintenance task or repair that may require extended ground time resulting in a disruption or impact on flight operations. The airplane being replaced may also be identified by an inbound flight number. The inbound flight is the current flight leg of an airplane of interest, also identifiable by its tail number that may have experienced a fault while in flight that may require an unscheduled maintenance task or repair after landing. The next leg of the inbound flight or inbound tail or airplane may be referred to herein as the affected flight. Other valid airplane tails with compatible arrival and departure flight assignments, number of seats, other compatibility features or characteristics for the airport of interest, where the inbound flight will be landing, may be referred to herein as candidate flights, swap options, tail options, tail candidates, or similar terms. One skilled in the art could extend this specific example to other industries where a fleet of vehicles are employed and maintained such as ships or watercraft, terrestrial vehicles or others.

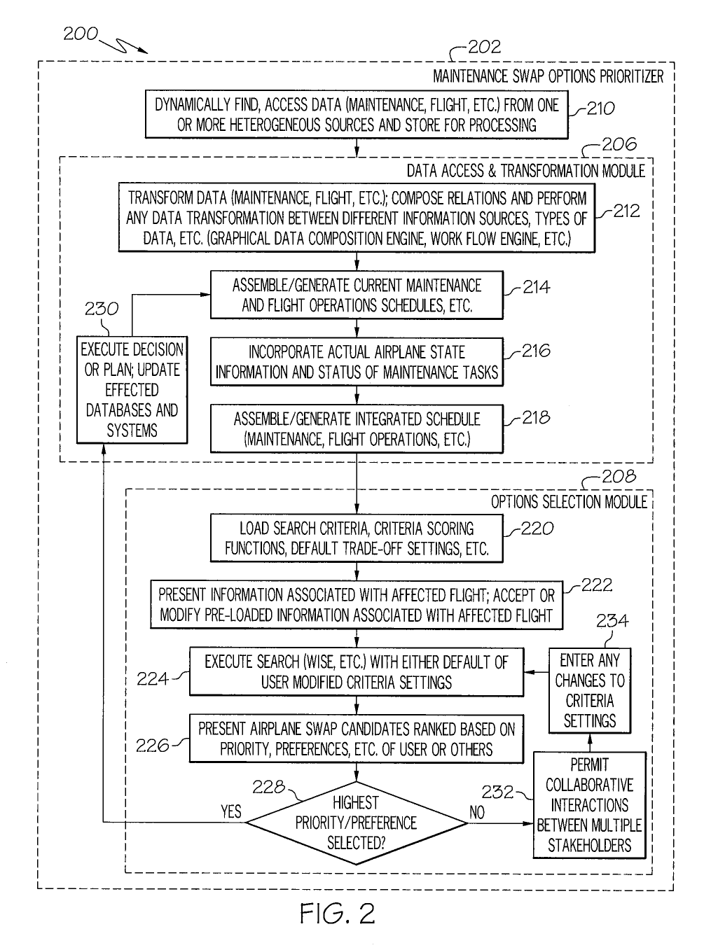

The newly invented Boeing system 100 may include a maintenance swap options prioritizer 102. The maintenance swap options prioritizer (MSOP) 102 may be operable on a server or processor 104. The MSOP 102 may include a data access and transformation module 106 and an options selection module 108. The MSOP 102 or data access and transformation module 106 may dynamically find, retrieve, or access and assemble information from different sources for generating maintenance and other transportation operations schedule tables such as flight schedule tables and/or similar tables related to generating a list of swap options as described in this disclosure. The options selection module 108 may use integrated schedules generated by the data access and transformation module 106 to generate a list of prioritized swap options 110 as described in more detail herein. The options selection module 108 or MSOP 102 may also generate inbound transportation attributes, affected transportation attributes, candidate transportation attributes, associated performance metrics, and impacts for different potential swap options. The list of prioritized swap options, inbound transportation attributes, affected transportation attributes, candidate attributes, associated performance metrics and impacts may be based on the information found and assembled by the data access and transformation module 106 and based on any user criteria, such as preferences or objectives or other criteria as described in more detail herein. Examples of operations or functions that may be performed by the MSOP 102, the data access and transformation module 106 and the options selection module 108 will be described in more detail with reference to FIG. 2.

The MSOP 102 or data access and transformation module 106 may access information or data via a network 112 or networks. The network 112 may be the Internet, private network or other secure, dedicated network. The MSOP 102 or data access and transformation module 106 may retrieve the information from a maintenance engineering management (MEM) system 114 or similar system. The MEM system 114 may gather information from multiple sources including the information or data needed or desired for the MSOP 102. The MEM 114 may define a hub for collecting or receiving flight information, maintenance information and other data from multiple heterogeneous sources that may be used by the MSOP 102 as well as other systems or entities. Examples of different sources from which information or data may be gathered by the MEM 114 may include real-time flight operations schedules 116, maintenance schedules for aircraft 118, Airplane Health Management (AHM) 120, information from an Electronic Logbook 122 or similar logbooks, Integrated Materials Management (IMM) data sources 122, minimum equipment list (MEL) data sources 125 and any other data or information that may be helpful in evaluating different maintenance options or decisions or computing performance data or metrics. The MEM 114 may access the different sources 116-125 via a network 126 or networks. The network 126 may be same network as network 112 or may be a different dedicated network or networks.

The data access and transformation module 106 may compose relationships between the data from the different sources, such as flight and maintenance schedule tables and similar data sources (i.e., relational database tables, web services, etc.), and perform any appropriate or needed transformations. The data access and transformation module may then generate maintenance and flight schedule tables 128, the integrated schedule or other grouping, schedules or tables of data that may be helpful in generating the list of swap options 110, computing performance data and determining inbound flight attributes, affected flight attributes, candidate attributes and associated performance metrics and impacts on operations.

An example of a module, application or similar means that may be used for the data access and transformation module 106 may be the graphical data composition and workflow technology available from Commonwealth Scientific & Industrial Research Organization (CSIRO) in Australia. CSIRO is a trademark of the Commonwealth Scientific & Industrial Research Organization in the United States, other countries or both. Data composition technology may aggregate data from multiple heterogeneous data sources, pre-process text for semantic fact extraction, automatically generate alerts using information retrieval agents, and generate content tailored to a user's role and purview and may automatically deliver reports. Data composition technology may be used in situations where data context is important and evolving; where domain experts need a graphical user interface to allow them to query data sources without having to write code or queries; where automatic retrieval of actionable information from dynamic data sources over standard communications protocols is needed; and where content delivery may be tailored to user role and access rules, to a particular display and platform environment or other customization of output results depending upon needs or preferences.

The data access and transformation module 106 or data composition engine may automatically access and dynamically manage the data sources. The module 106 or data composition engine adheres to Service Oriented Architecture (SOA) web standards. The data composition engine or module 106 includes a suite of graphical tools to dynamically find and assemble the information needed for the MSOP search engine 108. The data composition or module 106 includes a work flow engine that is used to graphically compose the relations and data transformations between the information sources 116-125. These workflows may be deployed as web services over a network, such as network 126 and may be used to populate the options selection module's data tables and to keep the MSOP 102 information up to date.

An example of a module or application that may be used for the options selection module 108 may be a Weighted Intelligence Search Engine (WISE) technology as provided by Auguri Corporation of San Carlos Calif. The WISE technology can provide a prioritized list of results based on a set of input data and other criteria. WISE technology can provide efficient, intelligent data query capability for large relational databases. The WISE technology can combine multiple criteria with individual weights to perform trade-off searches that best match a user's business needs, operational preferences or other criteria. The WISE technology or options selection module 108 can generate prioritized results in a single search despite incomplete data. The WISE technology or options selection module 108 may consider multiple options in a search and can enable multiple users 130 to share assessment impacts and collaborate on decision making and dynamic planning to manage maintenance, repairs and flight operations.

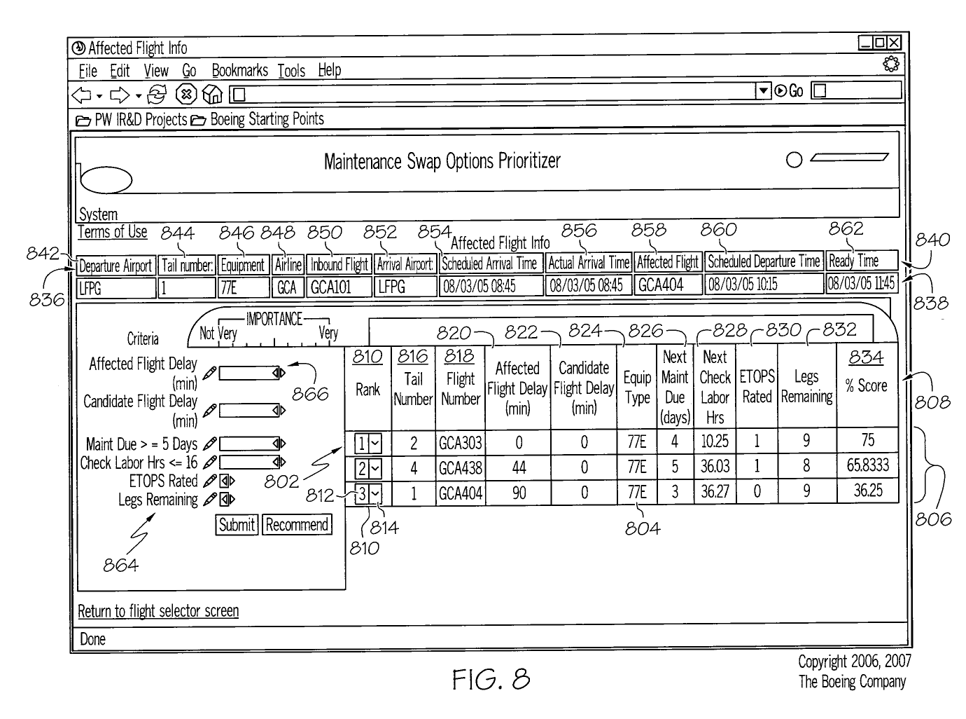

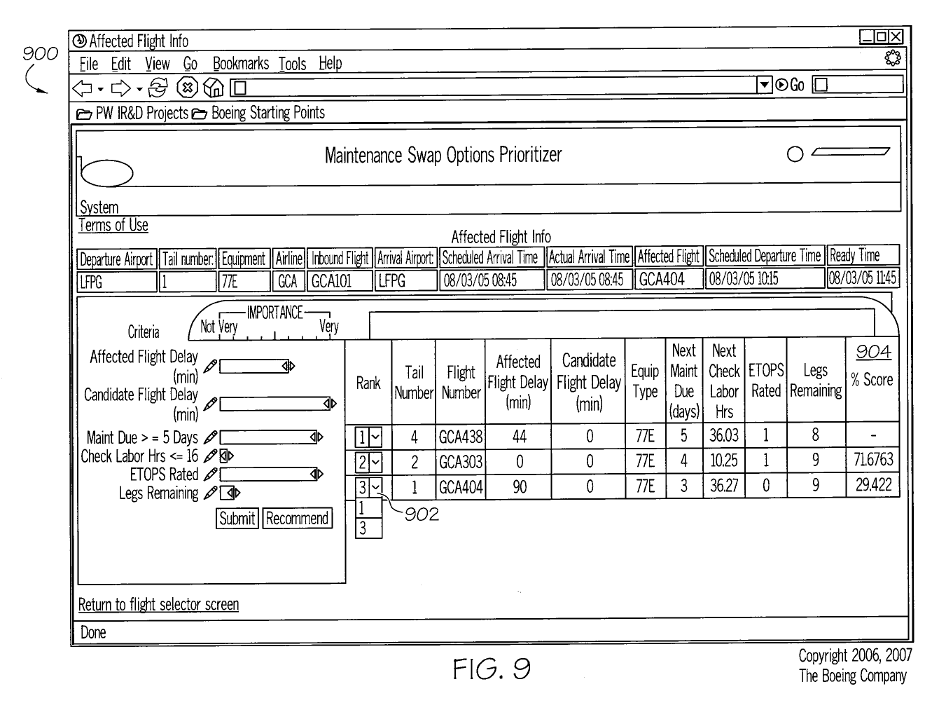

The MSOP 102 may generate a graphical user interface or interfaces (GUI) 132 to permit user preferences, criteria associated with prioritizing the swap options, trade-off settings associated with prioritizing the swap options or other inputs to be entered and/or edited by a user or planner. The GUIs 132 generated by the MSOP 102 may also include GUIs to present the list of prioritized swap options 110 and performance data to one or more users 130 and to permit collaborative interactions between the multiple users 130 for decision making and dynamic planning of flight and maintenance operations. The GUIs 132 may present inbound flight attributes, affected flight attributes, candidate attributes, associated performance metrics and impacts for different potential swap options that may be selected. Current flight schedule impacts and down stream consequences or delay ripple effects for a predetermined planning horizon for a selected swap option may also be presented. Example of the GUIs 132 that may be generated and presented to the user 130 or users will be described with reference to FIGS. 8 and 9.

The MSOP 102 may be accessed by multiple users via a network 134. The network 134 may be the Internet, private network or other secure or dedicated networks. The networks 134, 112 and 126 may be the same or different networks. The MSOP 102 also permits one or multiple users 130 to enter criteria, such as preferences, objectives, policies or other parameters as will be described with respect to the exemplary GUIs in FIGS. 8 and 9, so that each of the different users 130 interests may be considered in the options prioritization process. The MSOP 102 may also permit collaborative decision making and planning by the multiple users 130. Examples of the different users 130 that may be involved in the process may include a maintenance, repair and overhaul (MRO) controller 136, an airline maintenance planner 138, airline operational control and flight services providers, parts and materials providers, and any other technical service providers who may provide input for consideration in prioritizing the swap options and/or selecting between the options or tail swap candidates or who share resources (i.e., airport gates) and have competing interests that need to be protected.

FIG. 2 is a flow chart of an example of a method 200 for managing unscheduled maintenance and repair decisions in accordance with an embodiment of the present invention. As described in more detail herein, the method 200 computes performance data corresponding to performance metrics and provides prioritized maintenance swap options to facilitate maintenance and repair decisions and situational awareness. The method 200 may be embodied in and performed by the system 100 of FIG. 1. The different operations or functions associated with the method 200 are divided into functions or operations that may typically be performed by the maintenance swap options prioritizer 202, the data access and transformation module 206 and the options selection module 208. The maintenance swap options prioritizer 202 may be the same as the maintenance swap options prioritizer 102 in FIG. 1. The data access and transformation module 206 may also be the same as the data access and transformation module 106 of FIG. 1, and the options selection module 208 may be the same as the options selection module 108 of FIG. 1.

In block 210, information for maintenance swap options may be dynamically found, retrieved or accessed from multiple heterogeneous data sources or other sources. The data sources may be the same as sources 116-125 of FIG. 1. Examples of the data that may be collected may include dynamic flight schedules or operations, aircraft state data, maintenance task data and other data or information that may be of use in prioritizing the different options, tail swap candidates or maintenance swap options and in computing performance data or metrics. The aircraft state data may include aircraft movements or flight movements from one location to another, current location, aircraft health status and the like. Examples of the different types of data that may be found or collected is also illustrated in the column headings 808 for the swap options 806 in the GUIs 800 and 900 illustrated in FIGS. 8 and 9. The collected data may be stored by the MSOP 202 for processing by the data access and transformation module 206 and options selection module 208.

In block 212, the data found in block 210 may be transformed. Relations between different kinds of information or information from different sources may be composed and any transformations between different kinds of information or from different sources may be performed.

In block 214, current maintenance and flight operations schedules and any other schedules or tables, that may be useful in prioritizing the different swap options, computing performance metrics or data and providing information as to the impact or consequences of any selected option, may be assembled or generated. In block 216, actual airplane state information and actual status of maintenance tasks may be incorporated into the schedules and/or tables generated in block 214.

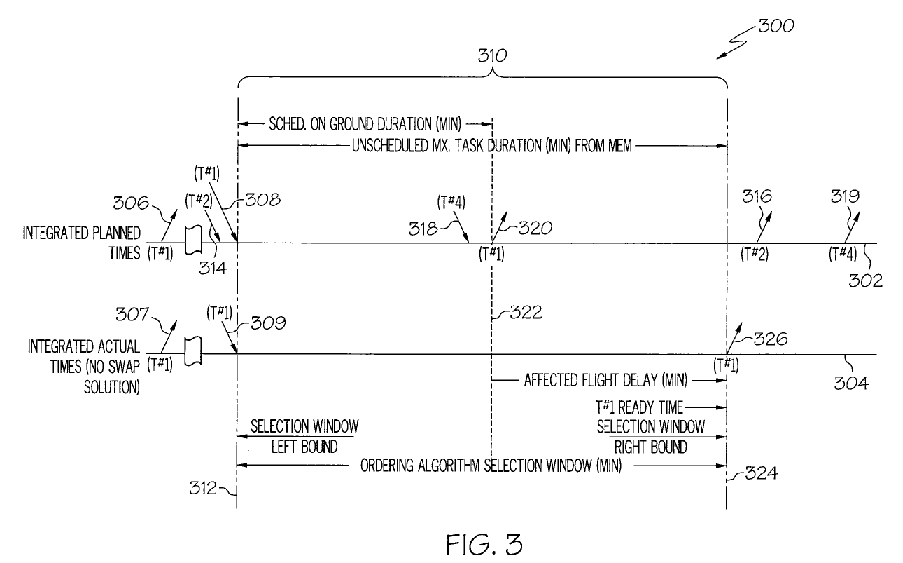

In block 218, the integrated-schedule for individual flights may be assembled or generated and stored in tables. Any other groups of different types of data, schedules or tables, that may be useful in prioritizing the different swap options, computing performance metrics and providing information as to the impact or consequences of any selected option may also be included in the integrated-schedules. The functions and operations in blocks 212-218 may be performed by the data access and transformation module 206, data composition engine or similar means. Examples of assembling or generating integrated schedules that may be performed by the data access and transformation module 206 or 106 of FIG. 1 will be described in more detail with reference to FIGS. 3-5.

In block 220, search criteria, criteria scoring functions, default trade-off settings and other parameters or criteria for finding and prioritizing any possible tail swap options or maintenance swap options may be loaded. Examples of the different search criteria, criteria scoring functions and trade-off settings and ways to adjust or select the criteria will be described with reference to FIGS. 8 and 9. The search criteria, criteria scoring functions, trade-off settings and other parameters may be pre-set to reflect the policies or preferences of the company, airline employee, maintenance planner, stakeholder or any entity that may have an interest in managing unscheduled maintenance tasks and repairs. As described herein these criteria or parameters may be adjusted to reflect the user, maintenance planner, company, airlines or other entity's preferences. The criteria or parameters may be adjusted as part of collaborative interactions between multiple stakeholders or interested parties as described herein.

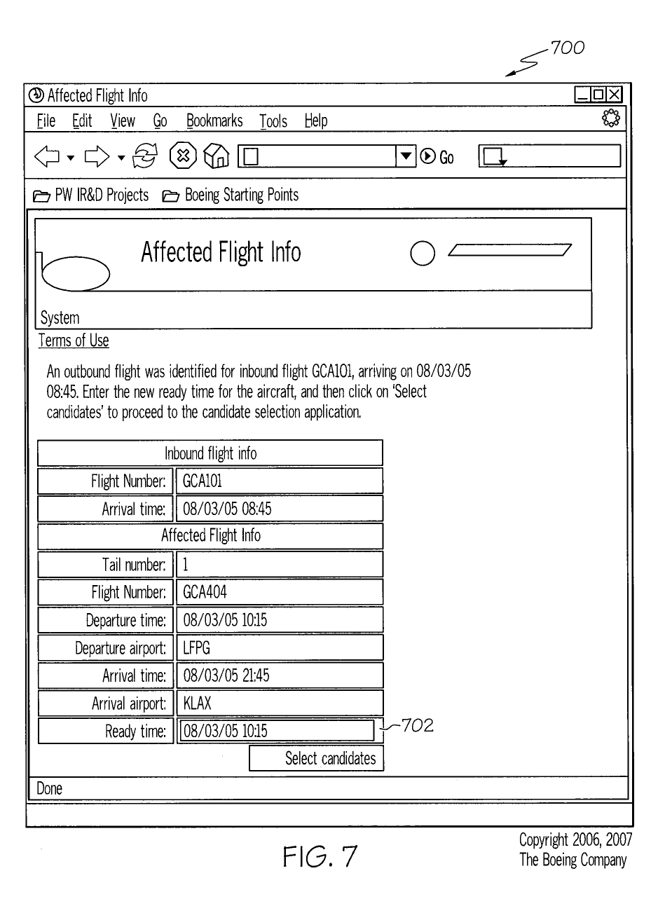

In block 222, information associated with an affected flight may be presented. Pre-loaded information associated with the affected flight, such as the search criteria and other parameters described in block 220 may be accepted or modified. An example of a GUI 700 for presenting the affected flight information will be described with reference to FIG. 7. A GUI 800 including a section for modifying any pre-set or pre-loaded search criteria or other parameters to search for possible swap options and to prioritize or rank such options or candidates will be described with reference to FIG. 8.

In block 224, a search for possible swap options or candidates may be executed with either default, pre-set or user modified criteria settings. The search may be performed by the Weighted Intelligent Search Engine (WISE) previously described or any other intelligent, options selection module.

Accordingly, unscheduled maintenance tasks and associated aircraft tail swap options or decisions may be assessed or evaluated. The options may be assessed while automatically taking into account various flight operation constraints. The assessment process may be dynamically controlled by using preferences and other criteria, such as business objectives, policies and the like that may be entered by a user similar to that previously discussed. Real-time maintenance schedules may be integrated with flight operation schedules. Aircraft state information may also be incorporated to more accurately prioritize decision options. Inbound flight attributes, affected flight attributes, candidate flight attributes, associated performance metrics, and impacts for different decision options may be determined and presented to a user or users.

In block 226, prioritized airplane swap candidates or maintenance swap options may be presented to one or more users in a virtual organization or other interested parties. Even though multiple users may view the results of swap options, control over the selection process will typically be vested in a single user, controller or planner responsible for overall decisions about on-time performance and program operations. The prioritized airplane swap candidates may be presented in a rank ordered list based on priority, preferences, or other criteria similar to that previously described. An example of a GUI including the rank ordered list of prioritized airplane swap candidates is illustrated in FIGS. 8 and 9.

In block 228, the responsible user makes the decision if a highest priority or preference airplane swap candidate in the rank ordered list is selected for implementation. If the highest priority candidate or option is selected by the responsible user or planner, the method 200 may advance to block 230. In block 230, the swap decision is communicated to connected systems. Any effected databases or systems may be updated and the method 200 may return to block 214. The method 200 may then proceed similar to that previously described when users are asked to evaluate other swap options for another inbound flight at a specified airport.

If the highest priority candidate or option is not selected in block 228, the method 200 may advance to block 232. In block 232, collaborative interactions between multiple users may be permitted. The different users may be similar to those previously described. The collaboration permits sharing of assessment impacts, leveraging common resources and/or infrastructure and collaboration on decision making, dynamic planning of operations as well as other benefits. Current schedule disruption, impacts and down stream consequences or delay ripple effects over the predetermined planning horizon may also be presented.

In block 234, after the different swap options and their respective impacts may be reviewed by the users, any changes to the criteria or settings may be entered. The method 200 may then return to block 224 where a search of the possible airplane swap options or candidates may be executed according to the new criteria and settings. The method 200 may then proceed as previously described until a highest priority preference is selected in block 228.

The functions or operations of blocks 220-228, 232 and 234 may be performed by the options selection module 208, 108 in FIG. 1, or similar options selection engine.

FIG. 3 is an illustration of an example of an integrated schedule 300 including timelines 302 and 304 of the integrated schedule representing scheduled or actual maintenance and repair events, and scheduled or actual flight events over a multi-days planning horizon (i.e., typically 5-7 days) in accordance with an embodiment of the present invention. The integration of scheduled maintenance and scheduled flight events on a single timeline provides situational awareness of planned events in accordance with an embodiment of the present invention. Separately, the integration of actual maintenance and actual flight events on another timeline provides situational awareness of actual events in accordance with an embodiment of the present invention. The integrated schedule is dynamic in the sense that the data access and transformation module 106 continuously updates it with new or updated data. As previously discussed, the integrate schedules' two integrated timelines include the following types of flights: an “Inbound Flight” may be defined as a current flight leg of an airplane (airplane tail or tail number of interest) that is experiencing a fault while in flight requiring unscheduled maintenance after landing. An “Affected Flight” may be defined as the next leg of the inbound airplane tail or Inbound Flight. “Candidate Flights” may be defined as other valid aircraft or airplane tails with compatible arrival-departure flight assignments for the airport of interest. The airport of interest is the airport where the Inbound Flight is scheduled or destined to land. The MSOP system may reference flight numbers which are invariant to associated parametric results rather than tail numbers whose flight assignment differ before and after the swap decision. This makes the GUIs, such as GUIs 800 and 900 in FIGS. 8 and 9 more understandable since parametric attributes are uniquely associated to a flight.

The integrated schedule 300 illustrates an inbound flight with a tail number 1 represented by “T#1” in FIG. 3 arriving at a particular airport of interest. The integrated schedule for the entire planning horizon can be concentrated to view a snapshot in time 300 while the airplane is inbound to the airport of interest. The integrated schedule concentrated view 300 could be representative of a maintenance planner looking at his swap options for the next leg of the inbound flight (i.e., the affected flight). The integrated schedule 300 may include all planned events over the planning horizon represented on an integrated planned timeline 302, as may be reported by systems storing information such as maintenance schedules 118 and flight schedules 116 in FIG. 1. The integrated schedule 300 may include all known completed events or actual event times represented on an integrated actual timeline 304, as may be reported by flight tracking sensors, airplane health management (120 in FIG. 1) or other sensors and systems. The planned timeline 302 for planned operations and the actual timeline 304 for actual operations may be representative of known events up to the current time. The actual timeline 304 can also include projections of downstream events. Upward slanting arrows on the planned timeline 302, such as arrow 306, indicate a point in time an airplane is scheduled to depart, and upward slanting arrows on the actual timeline 304, such as arrow 307, indicate a point in time an airplane has actually departed. Downward slanting arrows on the planned timeline 302, such as arrow 308, represent the point in time an airplane is scheduled to arrive and downward slanting arrows on the actual timeline 304, such as arrow 309, indicate a point in time an airplane has actually arrived. The integrated schedule 300 or timelines 302 and 304 also show other airplanes on the ground at the airport of interest when T#1 is on the ground. In this case, we assume these flights have been filtered to be from the same airline as T#1. In some instances (i.e., 306, 307, 410, 418, etc.), we are showing departures from other airports on inbound flight legs associated with affected or candidate flights.

With reference to FIGS. 3-5, an example will be described of how the search algorithm identifies airplane tail numbers that may be possible tail swap candidates. The search algorithm executed in block 224 of FIG. 2, may use individual airplanes' integrated schedules 300 to identify and rank by priority valid arrival-departure flight pairs. The search algorithm uses a moving selection window 310 to dynamically select valid arrival-departure pairs. The selection window is bound by the attributes of the inbound and affected flight information and anchored on the inbound flight's actual arrival time 312. The inbound flight's actual arrival time also corresponds to the downward slanting arrow 309 for T#1 on the integrated actual timeline 304. The selection window 310 width is determined by the largest of the inbound flight's scheduled on ground (lay-over) time or the time period to repair the fault or perform the required maintenance task. The width of the selection window 310 is dynamic because airplane repair times and actual airplane state information are provided from external real-time health management monitoring and airplane tracking data sources. The airplane repair time is typically manually entered by a maintenance planner on the affected flight info page but may be directly extracted from either a MEM system or Airplane Health Maintenance (AHM) system, such as systems 114 and 120 in FIG. 1. The actual airplane state information may cause dynamic updates to the integrated actual timeline 304 resulting from ongoing updates to the flight operations schedules and may cause the selection window 310 to expand or slide. The result is a selection window that may change as a function of the latest updated integrated schedule information. The integrated schedule information of other airplanes (i.e., integrated planned times only) is also shown on the integrated planned timeline 302 in FIG. 3. For example, planned arrival time 314 and departure time 316 for an airplane with tail number 2 (T#2) and planned arrival time 318 and departure time 319 for an airplane with tail number 4 (T#4) are represented on the integrated planned timeline 302. Any valid swap candidates are those airplanes on the ground within the selection window 310 and with a planned departure time later than the affected flight's ready time.

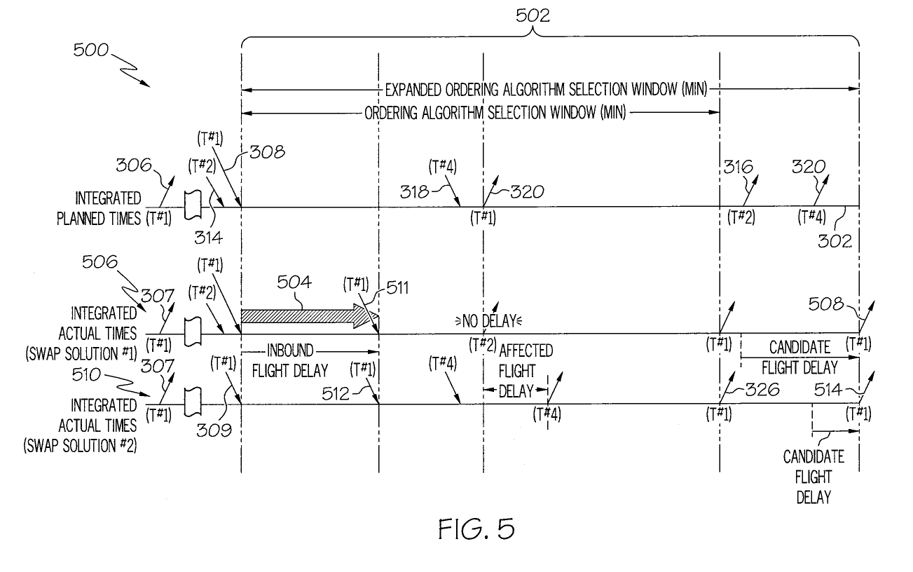

In the example illustrated in FIG. 3, it is assumed that the inbound flight T#1 has reported a fault in flight and the repair time has been diagnosed to be 180 minutes. T#1's scheduled flight arrival and departure times at the airport of interest are illustrated as down arrow 308 and up arrow 320 at dashed or broken lines 312 and 322 respectively. A revised actual departure time, is twice the scheduled ground time as illustrated by the T#1 up arrow 326 at dashed or broken line 324. In FIG. 3, this situation is illustrated where the airplane selection window's left bound is anchored on the inbound flight's scheduled/actual arrival time 312, since T#1 is arriving on time. Given the affected flight's 180 minutes unscheduled maintenance task duration, the selection window's right bound 324 is then the affected flight's ready time for the next flight leg as illustrated by the T#1 up arrow 326 on the integrated actual timeline 304. The up arrow 326 on the integrated actual timeline 304 also illustrates a result or solution when the airplane T#1 is not replaced by another swap candidate (T#2 or T#4) which may be referred to as the no swap solution. T#1's actual departure time corresponding to arrow 326 has slid or moved because of the additional 90 minutes repair time. The integrated planned timeline 302 also shows the swap candidates (T#2 and T#4) integrated schedules used by the search algorithm to prioritize swap options. The affected flight's 90 minutes maintenance caused delay is reported on an MSOP graphical user interface 800 in FIG. 8 as represented by the cell headings labeled “Ready Time” 862, “Affected Flight Delay” 820. The 90 minutes maintenance delay is included in the displayed actual ready time 862 and the actual delay value for the third swap decision option and provides planners with increased awareness of the overall situation of all the airline's flights at the airport of interest. An example of an inbound flight delay situation where the expanded selection window's right bound 324 is anchored on the candidate flight's actual departure time is illustrated in FIG. 5.

Given a valid swap candidate list derived at a given airport from the integrated schedule information 300, an options selection module, such as options selection module 108 in FIG. 1 or 208 in FIG. 2, may calculate a cumulative score for each airplane swap candidate as the weighted sum of individual criterion scores. The weights are the trade-off preferences set by the user through the GUI 800. Each individual criteria score represents a normalized distance or variance between an ideal match (i.e., zero) and a poor match (i.e., one) of integrated schedule attributes, such as affected and candidate flight delay. Higher individual score values indicate an inferior fit with the criterion's ideal value. A value of 0 is a perfect match, and a 1 is a poor match (higher scores than 1 are allowed and indicate even poorer matches). 1 is a reasonable indicator that a match becomes too poor to be considered. Candidates with lower overall scores are closest to the ideal, and therefore represent the best available alternatives. In the examples given, zero minutes of delay is used as the ideal on-time dispatch value and 120 minutes as the worst case situation.

The integrated schedule of individual airplane tails or airplane tail numbers may contain other attributes on which the search algorithm may prioritize swap candidates, such as next maintenance due, Extended range Twin engine Operations (ETOPS) rating for any extended operations over water, legs remaining, and similar attributes. Other search criteria, such as next maintenance due and next maintenance check labor hours, are simply ranked by a Boolean value with 10% the current ideal value for a true condition and 90% the value for a false condition. Examples of setting and adjusting or modifying these attributes will be described with reference to FIG. 8. Examples of different criterion and setting criterion weights will also be described in more detail with reference to the MSOP GUI 800 illustrated in FIG. 8.

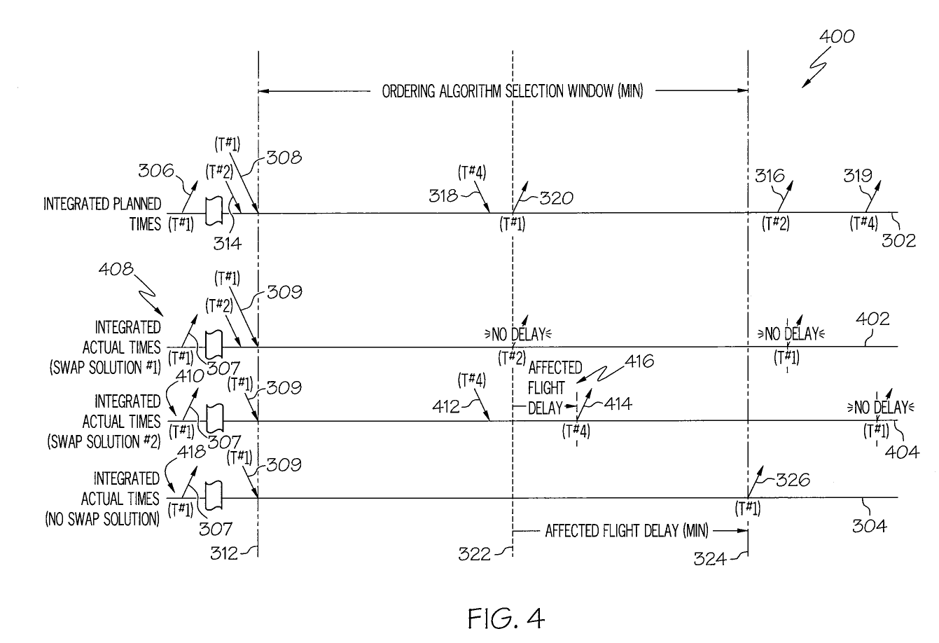

FIG. 4 is an illustration of an example of timelines 400 of integrated-schedule events depicting different possible solutions or swap options to facilitate maintenance and repair decisions and situational awareness in accordance with an embodiment of the present invention. FIG. 4 continues the example of FIG. 3 illustrating swap options involving selection of either one of the other swap candidates, T#2 and T#4. FIG. 4 illustrates three solutions on three separate integrated actuals timelines 402, 404 and 406. Swap solution 1408 illustrates the swap between T#1 and T#2, where T#2 will service T#1's outbound flight without any delay resulting from the swap. Swap solution 2 410 illustrates how T#4 is a valid swap candidate but has limited turn around time because of the short duration between T#4's arrival time (T#4 down arrow 412) and departure time (T#4 up arrow 414). This results in a swap with an affected flight delay 416 as illustrated in FIG. 4.

Swap solution 3 418 is the same no swap solution illustrated in FIG. 3 and previously described. All three swap options 408, 410 and 418 or solutions are listed on the MSOP GUI 800 in FIG. 8 as swap options 806 (swap options can be the affected flight or one or several candidate flights) along with information or performance data or metrics related to each tail swap candidate to assist a user or planner to manage unscheduled maintenance decisions and to provide the user or planner with situational awareness. Examples of the information or performance metrics that may be presented with each tail swap option or candidate will be described in more detail along with MSOP GUI 800 with reference to FIG. 8.

FIG. 5 is an illustration of an example of timelines 500 of integrated-schedule events depicting different possible solutions or swap options to facilitate maintenance and repair decisions and situational awareness in accordance with an embodiment of the present invention. FIG. 5 illustrates the case of an expanded selection window 502 where external flight tracking sources have detected an inbound flight delay 504 and updated T#1's integrated schedule information with the inbound flight delay data (notice that the horizontal arrow 504 depicting the inbound flight's arrival delay affects both swap solution shown on timelines 506 and 510). The data access and transformation module 106 in FIGS. 1 and 206 in FIG. 2 will update the search algorithm's input tables 128 with this additional delay data (e.g., actual times). FIG. 5 illustrates results for the same solutions 1 and 2 as in FIG. 4 with the results being slightly changed in FIG. 5 as follows. Solution 1 506, where T#2 is the swap for T#1, is still a solution without an affected flight delay but the late inbound flight arrival (i.e., T#1 down arrow 511) results in a delay ripple on the candidate flight (i.e., T#1 up arrow 508). Solution 2 510 is still a solution with a slight affected flight delay but the late inbound flight arrival (T#1 down arrow 512) results in a delay ripple on the candidate flight (i.e., T#1 up arrow 514). The no swap solution is not illustrated in FIG. 5 but would result in the late inbound flight arrival rippling into the corresponding affected flight delay.

FIG. 5 illustrates the situational awareness benefits of a performance based MSOP system, such as system 100 of FIG. 1 and method 200 of FIG. 2. The integrated schedule delay metrics, when updated in real-time, provide a measure of service quality (e.g., on-time departure) to the responsible planner as well as a means to quantify the impact of unplanned events on overall schedule performance. This provides the responsible planner a much more effective means of prioritizing re-planning decision options in the face of disrupted maintenance events. As previously discussed, the performance based implementation provides avenues for the responsible user or planner to actively collaborate with others, such as external technical service providers, partners or other parties whose resources are being shared (e.g., MRO hangar or tool resources, etc.) These collaborators have an interest in how swap decisions may affect the planning of their owned resources, which may be conflicting with flight or other users' priorities. For instance, an airline maintenance planner, after consulting with the flight department, may deem that T#4's 44 minutes of delay is of negligible impact. However, this information may tell the responsible planner that delaying maintenance for an extra day is a more valuable consideration in this particular situation (see T#4 next maintenance due attribute 826 listed as due in 5 days in FIG. 8). The responsible planner could either change the weight on the affected flight delay criteria or overwrite the selection of T#2 as the selected swap candidate to execute this swap and in the process better balance the conflicting flight operations and maintenance impacts.

The integrated schedule 300, 400 or 500 may also include additional gate and airline flight operations events, such as late fuel trucks, baggage delivery or other events of interest, to maximize the effectiveness of the situational awareness and managing swap decisions using the MSOP system and method. The prioritized list can represent an airline customer's entire operation and provide situational awareness for an entire planning horizon which could include the airline's entire operation in addition to a particular gate or maintenance station. Additionally, the MSOP system and method of the embodiments of the present invention may provide a much enhanced “rear view mirror” into the state of an airline's operations or root causes of any operational situation in near real time.

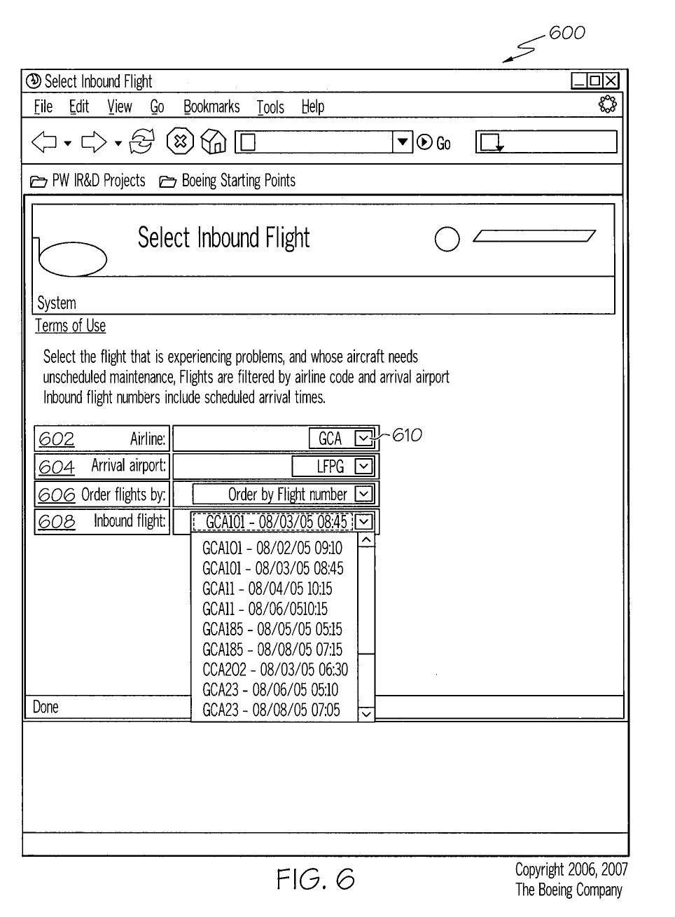

FIG. 6 is an illustration of an example of a graphical user interface (GUI) 600 for selecting or entering an inbound flight, on which a need for an unscheduled maintenance task has arisen, into a system for managing maintenance and repair decisions in accordance with an embodiment of the present invention. The GUI 600 may be used by a maintenance planner or other user of the system 100 to initially enter the inbound flight information for generating possible tail swap options or candidates as previously discussed. Examples of the information that may be entered may include the airline 602, the arrival airport 604, selection of how inbound flights may be ordered or arranged 606, and the inbound flight number 608. Any additional data or information that may be helpful in the MSOP process may also be entered or provided. As illustrated in FIG. 6, the information may be entered by selecting from a drop down list that may be presented in response to a computer pointing device being positioned over a list or menu indicator 610 associated with each information field. The choices for each successive drop down list or menu may be limited based on previous selections. For example, there may only be certain inbound flights for a selected airline and arrival airport. The information may also be entered in other ways as is commonly known with respect to entering data or information into a GUI.

FIG. 7 is an illustration of an example of a graphical user interface (GUI) 700 for presenting the inbound flight information selected or entered in FIG. 6 and for entering an outbound or affected flight ready time in accordance with an embodiment of the present invention. A maintenance planner may then enter a ready time 702 based on an expected repair time for the fault. This information may then be used by the MSOP system and method to generate the list of possible tail swap options or candidates as previously described and as illustrated in FIGS. 8 and 9.

FIG. 8 is an illustration of an example of a graphical user interface (GUI) 800 for displaying options to resolve unscheduled maintenance and repairs and to make decisions in accordance with an embodiment of the present invention. The GUI 800 may provide prioritized maintenance swap options or tail swap candidates to facilitate maintenance and repair decisions and enhance situational awareness. The GUI 800 may be generated by the system 100 of FIG. 1 or the method 200 of FIG. 2. Similar to that previously discussed, the GUI 800 may present a ranked list 802 of prioritized swap options. The ranked list 802 may include a plurality of cells 804 or fields indicating different data or information that may be useful in selecting a particular swap option. Each swap option 806 (notice that swap options can be the affected flight in the case of a no swap decision or one or several candidate flights) and associated data or information may be arranged in a row. The fields 804 may be arranged in columns with a heading 808 for each column identifying or describing an attribute corresponding to the data or associated performance metric contained in the respective cells 804 for each swap option 806. A first column 810 which may be on the left may contain the rank order for each swap option 806. Each rank order field 812 may include a feature 814 to permit the rank order to be overridden by a user. Examples of the other attributes data associated with each swap option or affected and/or candidate flights and the associated column heading may include “Tail Number” 816 of the swap option or affected and/or candidate flights, “Flight Number” 818 of the swap option or affected and/or candidate flights, “Affected Flight Delay” 820 in minutes, “Candidate Flight Delay” 822 in minutes, “Equip Type” 824 of swap option or affected and/or candidate flights, “Next Due Maint Due” 826 or time to the next scheduled maintenance in days, “Next Check Labor Hrs” 828 for the swap option, “ETOPS Rated” 830 (airplane rated to operate for extended operations over water on a single engine), “Legs Remaining” 832 (flight legs remaining before end of flight schedule or other operation), “% Score” 834 associated with the particular swap option. The overall % score is a prioritization score relative to an ideal of 1 (notice this is the reverse of the search algorithm scoring criteria). This is to help the GUI 800 represent what is a user's common understanding of a relative value as close to 100%. The ranked list 802 or table defines the updated tables of integrated schedules 110 and is transferred to the maintenance and flight schedule tables 128 at the time of a swap execution 230 similar to that previously discussed. The headings define attributes associated with each of the possible swap options or affected and/or candidate flights or 806 listed on timelines 302 and 304.

The inbound flight with an unscheduled maintenance task may be presented in an “Affected Flight Info” section 836 of the GUI 800. The affected flight information section 836 may also include a plurality of data fields or cells 838 in columns with a column heading 840 designating or identifying attributes of the inbound and affected flights and associated performance metrics or data in the field or cell 838. Examples of the different types of attributes and performance metrics or data and column headings 840 may include “Departure Airport” 842, “Tail Number” 844, “Equipment” 846, “Airline” 848, “Inbound Flight” 850, “Arrival Airport” 852, “Scheduled Arrival Time” 854 “Actual Arrival Time” 856, “Affected Flight” 858, “Scheduled Departure Time” 860, “Ready Time” 862. These different headings may be defined as the attributes of the inbound and affected flights.

The GUI 800 may also include a section 864 for users or a planner to enter or select criteria, such as preferences, business objectives, policies or the like for use in generating the prioritized list of swap options 806. Examples of the criteria may include Affected Flight Delay; Candidate Flight Delay; Next Maintenance Due as a Boolean value in days greater than or equal to 5 days (or some other predetermined number of days); Check Labor Hours as a Boolean value for the next maintenance tasks requiring less than or equal to 16 hours (or some other predetermined number of hours); ETOPS Rated (a minimum equipment list (MEL) constraint for over water operations, i.e., Extended Twin Engine Operations) also a Boolean value set to True if the airplane is ETOPS qualified/rated; and Legs Remaining for the aircraft. Each criterion may also include a feature 866, such as a slider bar, individual trade-off criteria setting, or similar means, to permit a user to set a criteria trade-off setting or weighted scoring value. For example, the trade-off setting may be set according to an importance ranging between not very important to very important corresponding to an actual value between 0 and 1 respectively.

The output result of the system and method is the list 802 of tail swap candidates or options 806 for the affected flight indicated by the ranked list in FIG. 8. The list 802 is shown in rank order and can be scrolled to show more candidates, if need be. The percent score 834 achieved by the search engine is indicated in the extreme right column of the list 802. The search results may be displayed relative to an ideal value of 1 (i.e., 100%). As previously described, between the rank 810 and percent overall score 834 columns are attributes and corresponding data or performance metrics identifying the swap candidates and supporting rationale for the ranking.

FIG. 8 illustrates the operations of blocks 222-228, and several iterations of operations 232-234-224-226 in accordance with the embodiments of the invention. In the example in FIG. 8, the operations of a responsible planner may be focused on minimizing delay and maintenance impacts. His initial trade-off values may assign the same importance to delay and maintenance criteria and leave out of the analysis for ETOPS and legs remaining criteria. In a subsequent iteration of the swap analysis cycle, specifying settings for the number of flight legs still to be flown may be done. Legs remaining allow the responsible planner to select a candidate that is less likely to propagate delay by providing a higher ranking if 5 or fewer legs remain. The ETOPS rated criteria can be used in this subsequent cycle to eliminate flights (i.e., lower the score considerably) that do not meet ETOPS criteria. The responsible planner can use this criteria when the next flight leg has over-water operational requirements. In this example, the responsible planner can iterate until he and other partners are satisfied that their preferences are fairly reflected in the selected swap decision.

FIG. 9 is an illustration of an example of a graphical user interface 900 for promoting or changing the ranking of a maintenance swap option or candidate in accordance with an embodiment of the present invention. The GUI 900 may include a pull-down widget feature 902 or similar feature to force the ranking of a particular flight to the top. Thus, the planner may, optionally, be given the ability to force a selected candidate to be ranked first, as illustrated in FIG. 9. This feature 902 provides flexibility for handling exceptional situations not taken into account by the programmed business rules or other criteria. GUI 900 also illustrates the results from forcing flight GCA438 (i.e., T#4) to the top of the list. The system may also infer criteria trade-off values that would generate such results and adjusts the criteria trade-off settings on GUI 900. Additionally, when promoting a candidate, the score value 904 is left blank.

One salient characteristic about the system and method or algorithm is that the ranking order 812 and score values 834 are computed as cumulative sums and will remain unchanged if the planner slides the trade-off criteria settings 866 to new settings but leave relative settings identical. The overall ranking score 834 for identical trade-off settings of 25%, 75% or 100% remains constant and identical to the 50% trade-off criteria setting results (the initial default settings) illustrated in FIG. 8. This characteristic holds true in the cases where only 4 out of 6 criteria trade-off settings are maintained identical across the list of user preference criteria (i.e., first four settings at 50%) and the remainder are set to zero. So, rankings are constant if the slider bars 866 are moved simultaneously and/or some are left at zero (at least one slider bar 866 must be different from zero for a feasible solution).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A system for managing unscheduled maintenance and repair decisions, comprising:
a maintenance swap options prioritizer comprising:
a data access and transformation module to find and assemble information from different sources for computing performance data and generating a list of prioritized swap options;
a options selection module to generate the list of prioritized swap options based on the information found and assembled by the data access and transformation module and based on any user preferences;
means to present the performance data and the list of prioritized swap options to at least one user; and
means to permit collaborative decision making and planning by multiple users to manage shared maintenance and repair resources.

2. The system of claim 1, wherein the data access and transformation module dynamically finds and assembles a group of data including dynamic flight schedules, airplane state data, and airplane maintenance data from different heterogeneous sources to derive a set of operational performance metrics, wherein the set of operation performance metrics comprise any inbound flight delay, any affected flight delay, any candidate flight delay or other user defined performance metrics.

3. The system of claim 2, wherein the maintenance swap options prioritizer comprises a module to generate an integrated schedule.

4. The system of claim 1, further comprising a graphical user interface generable by the maintenance swap options prioritizer to permit user preferences, criteria associated with prioritizing the swap options, and trade-off settings associated with prioritizing the swap options, to be entered and edited.

5. The system of claim 1, further comprising a graphical user interface generable by the maintenance swap options prioritizer to permit collaborative interactions between the multiple users for decision making and dynamic planning of flight and maintenance operations.

6. The system of claim 1, wherein the maintenance swap options prioritizer comprises:
means to determine inbound flight attributes, affected flight attributes, candidate flight attributes, associated performance metrics, and impacts for different potential swap options; and
means to present a graphical user interface, wherein the graphical user interface comprises the inbound flight attributes, affected flight attributes, candidate flight attributes, associated performance metrics, and impacts under the different potential swap options.

7. The system of claim 1, wherein the maintenance swap options prioritizer is adapted to generate a graphical user interface comprising current flight schedule impacts measured by performance metrics and down stream consequences or delay ripple effects for a predetermined future planning horizon for each presented swap option.

8. The system of claim 1, further comprising a server, wherein the maintenance swap options prioritizer is operable on the server and wherein the maintenance swap options prioritizer is accessible via a network to permit the collaborative decision making and planning by the multiple users.

9. The system of claim 1, wherein the multiple users comprise a technical service provider, a flight services provider, and a parts and materials provider.

10. A method for managing unscheduled maintenance and repair decisions, comprising:
finding and assembling information from different sources for computing performance data and generating a list of prioritized swap options;
generating the list of prioritized swap options based on the information found and assembled from the different sources and based on any user preferences;
presenting the performance data and list of prioritized swap options to at least one user; and
permitting collaborative decision making and planning by multiple users to manage maintenance and repair decisions.

11. The method of claim 10, wherein presenting the performance data and list of prioritized swap options and permitting collaborative decision making and planning comprises:
presenting the performance data and list of prioritized swap options over a network; and
permitting the collaboration decision making and planning to manage flight and maintenance and repair operations over the network.

12. The method of claim 10, wherein finding and assembling information from different sources for computing performance data and generating the list of prioritized swap options comprises dynamically finding and assembling a group of data including dynamic flight schedules, airplane state data, and airplane maintenance data from different heterogeneous sources; and wherein the method further comprises deriving a set of operational performance metrics, the set of operational performance metrics including any inbound flight delay, any affected flight delay, any candidate flight delay or other user defined performance metrics.

13. The method of claim 10, further comprising generating an integrated schedule.

14. The method of claim 10, further comprising prioritizing the swap options in response to user preferences, criteria related to flight operations and maintenance schedules, and criteria trade-off settings.

15. The method of claim 10, further comprising:
integrating real-time maintenance schedules and flight operation schedules; and
incorporating aircraft state information to accurately prioritize swap options.

16. The method of claim 10, further comprising:
determining inbound flight attributes, affected flight attributes, candidate flight attributes, associated performance metrics, and impacts for different potential swap options; and
presenting the inbound flight attributes, affected flight attributes, candidate flight attributes, associated performance metrics, and impacts under the different potential swap options.

17. The method of claim 10, further comprising determining current flight schedule impacts measured by performance metrics and down stream consequences or delay ripple effects for a predetermined future planning horizon for each presented swap option.

18. A method for managing unscheduled maintenance and repair decisions, comprising:
permitting assessment of an unscheduled maintenance task associated with an airplane;
generating a list of potential prioritized airplane tail swap options;
presenting the list of potential prioritized airplane tail swap options; and
evaluating various flight operation constraints, maintenance constraints and user preferences in selecting one of the prioritized airplane tail swap options.

19. The method of claim 18, further comprising permitting collaborative decision making and planning to select one of the prioritized airplane tail swap options.

20. The method of claim 18, further comprising generating an integrated schedule to assess the unscheduled maintenance task.

21. The method of claim 18, further comprising determining a possible impact for each tail swap option before selecting the tail swap option.

22. A computer program product for managing unscheduled maintenance and repair decisions, the computer program product comprising:
a computer usable medium having computer usable program code embodied therewith, the computer usable medium comprising:
computer usable program code configured to find and assemble information from different sources for computing performance data and generating a list of prioritized swap options;
computer usable program code configured to compute the performance data and generate the list of prioritized swap options based on the information found and assembled from the different sources and based on any user preferences;
computer usable program code configured to present the performance data and list of prioritized swap options to at least one user; and
computer usable program code configured to permit collaborative decision making and planning by multiple users to manage maintenance and repair decisions.

23. The computer program product of claim 22, further comprising computer usable program code configured to generate an integrated schedule from dynamic flight schedules, airplane state data, and airplane maintenance data.

24. The computer program product of claim 22, further comprising computer usable program code configured to prioritize the swap options in response to user preferences, criteria related to flight operations and maintenance schedules, and criteria trade-off settings.

25. The computer program product of claim 22, further comprising:
computer usable program code configured to determine inbound flight attributes, affected flight attributes, candidate flight attributes, associated performance metrics, and impacts for different potential swap options; and
computer usable program code configured to present the inbound flight attributes, affected flight attributes, candidate flight attributes, associated performance metrics, and impacts under the different potential swap options to at least one user.
